(19) United States
(12) Patent Application Publication
(10) Pub. No.: US 2025/0215350 A1
(43) Pub. Date: Jul. 3, 2025

(54) CANDLE WAX COMPOSITIONS

(71) Applicant: CARGILL, INCORPORATED, Wayzata, MN (US)

(72) Inventors: Todd L. KURTH, Maple Grove, MN (US); Timothy Alan MURPHY, Albertville, MN (US); Yijun ZHOU, Maple Grove, MN (US)

(73) Assignee: CARGILL, INCORPORATED, Wayzata, MN (US)

(21) Appl. No.: 18/850,418

(22) PCT Filed: Mar. 30, 2023
(86) PCT No.: PCT/US2023/016928

§ 371 Date: Sep. 24, 2024

Related U.S. Application Data
(60) Provisional application No. 63/362,133, filed on Mar. 30, 2022.

(51) Int. Cl. C11C 5/00

(52) U.S. Cl. CPC C11C 5/002; C11C 5/006

(57) ABSTRACT

The present technology provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition that includes an esterification product of a pre-esterification mixture that includes: about 0.1 wt % to about 40 wt % a fatty acid dimer based on total weight of the pre-esterification mixture, about 99.9 wt % to about 60 wt % of one or more components selected from the group consisting of C2-C6 polyols, natural oils, hydrogenated natural oils, fatty acids, and acyl glycerols, based on total weight of the pre-esterification mixture, wherein the natural oil-based petrolatum composition has a cone penetration value of greater than 10 and a polydispersity index of greater than 1.3.

### CROSS-REFERENCE TO RELATED APPLICATIONS

This application claims the benefit of U.S. Provisional Application No. 63/362,133, filed Mar. 30, 2022, which is incorporated by reference herein in its entirety.

### TECHNICAL FIELD

This application relates to wax formulations, candle wax compositions and methods of making the same. In particular, this application relates to wax formulations and compositions that include natural oil based-petrolatum compositions.

### BACKGROUND

Natural waxes (namely beeswax) and petroleum-based waxes (namely paraffin wax) have been commonly used in to produce candles and other wax-based products. Paraffin, which replaced the more cost effective alternative to beeswax, became the primary industrial wax used to produce candles over a hundred years ago. Paraffin is produced from the residue left over from refining gasoline and motor oil, in connection with the petroleum refining industry.

There have been many efforts to replace petroleum based waxes with vegetable alternatives. Though many examples of vegetable based wax alternatives exist, there remains a need for suitable alternatives that have improved flexibility and utilities in specific candle applications.

Accordingly, it continues to be advantageous to have wax products, including candles, that have reduced amounts of petroleum-based ingredients and particularly including improved natural based materials that more closely mimic the texture, viscosity, stability, and melting profiles across a broad range of applications. Use a natural oil-based petrolatum like composition is one examples. Further, it would be environmentally and economically desirable if such materials were biodegradable and derived from renewable raw materials, such as natural oils.

### SUMMARY

The present disclosure provides a wax formulation that includes about 5 weight percent (wt %) to about 85 wt % of a natural oil-based petrolatum composition based on total weight of the wax formulation; and about 1 wt % to about 95 wt % of a wax material based on total weight of the wax formulation; wherein the natural oil-based petrolatum composition that includes an esterification product of a pre-esterification mixture that includes: about 0.1 wt % to about 40 wt % a fatty acid dimer based on total weight of the pre-esterification mixture, about 99.9 wt % to about 60 wt % of one or more components selected from the group consisting of C2-C6 polyols, natural oils, hydrogenated natural oils, fatty acids, and acyl glycerols, based on total weight of the pre-esterification mixture, wherein the natural oil-based petrolatum composition has a cone penetration value of greater than 10 and a polydispersity index greater than 1.3.

The present disclosure provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition that includes an esterification product of a pre-esterification mixture that includes: about 0.1 wt % to about 40 wt % a fatty acid dimer based on total weight of the pre-esterification mixture, about 99.9 wt % to about 60 wt % of one or more components selected from the group consisting of C2-C6 polyols, natural oils, hydrogenated natural oils, fatty acids, and acyl glycerols, based on total weight of the pre-esterification mixture, wherein the natural oil-based petrolatum composition has a cone penetration value of greater than 10.

The present disclosure further provides a method of making a wax formulation as described herein that includes: heating a wax material as described herein to a temperature wherein the wax material is in a molten state; and combining the wax material in a molten state with a natural oil-based petrolatum composition as described herein.

The present disclosure provides a candle wax composition that includes a wax formulation as described herein.

The present disclosure provides a candle that includes a wick in a candle wax composition as described herein.

Advantages, some of which are unexpected, are achieved by aspects of the present disclosure. For example, various formulations and compositions described herein advantageously improve fragrance throw.

As a further advantage, various aspects of the present disclosure described herein are natural oil-based and thus have the advantage of comprising biodegradable, renewable, and environmentally-friendly components. For example, the wax formulations of the present disclosure can be prepared from natural-based components (e.g., natural oil-based petrolatum and natural oil-based waxes) and yet can offer the above-described advantages.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

The term “or” is used to refer to a nonexclusive “or” unless otherwise indicated. The statement “at least one of A and B” has the same meaning as “A, B, or A and B.”

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, plus or minus within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the following terms have the following meanings unless expressly stated to the contrary.

As used herein, the term “natural oil” may refer to oil derived from plants or animal sources. The term “natural oil” includes natural oil derivatives (such as oils having undergone saponification, transesterification, esterification, interesterification, hydrogenation (partial or full), isomerization, fractionation, oxidation, and reduction), unless otherwise indicated. Examples of natural oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, jojoba oil, and castor oil. Representative non-limiting examples of animal fats include lard, tallow, poultry fat, yellow grease, and fish oil. Tall oils are by-products of wood pulp manufacture. In any aspect, the natural oil may be refined, bleached, and/or deodorized. In any aspect, the natural oil is present individually or as mixtures thereof.

As used herein, the term “hydrogenated natural oil” refers to partial, complete, or substantially complete hydrogenation of a natural oil. Partial or substantially complete hydrogenation of natural oils is well known in the art and many hydrogenated natural oils may be purchased on the market and are available from a variety of commercial sources.

The natural oil may be an “interesterified natural oil(s)”. As used herein, the term “interesterification” or “interesterified” refers to a method of rearranging and redistributing the fatty acid on the glycerol fragment of triglycerides present in the natural oil. The rearrangement and redistribution does not change the overall composition of the fatty acids on the starting materials. Interesterification of an edible oil may be carried out chemically or enzymatically.

As used herein, a “natural oil-based” composition means that the composition contains oils and fatty acids which are predominantly, substantially or entirely, derived from natural oils and natural oil derivatives. The natural oil-based composition may, in any aspect, contain oils which are at least 50%, 55%, 60%, 65%, 70%, 75%, 80%, 85%, 90%, 95%, 99%, 99.9%, 99.99% or about 100% natural oil or hydrogenated natural oil.

A “monoacylglyceride” refers to a molecule having a glycerol moiety with a single fatty acid residue that is linked via an ester bond. The terms “monoacylglycerol,” “monoacylglyceride,” “monoglyceride,” and “MAG” are used interchangeably herein. Monoacylglycerides include 2-acylglycerides and 1-acylglycerides.

A “diacylglyceride” refers to a molecule having a glycerol moiety having two fatty acid residues linked via ester bonds. The terms “diacylglycerol,” “diacylglyceride,” “diglyceride,” and “DAG” are used interchangeably herein. Diacylglycerides include 1,2-diacylglycerides and 1,3-diacylglycerides.

A “triacylglyceride” refers to a molecule having a glycerol moiety that is linked to three fatty acid residues via ester bonds. The terms “triacylglycerol,” “triacylglyceride,” “triglyceride,” and “TAG” are used interchangeably herein.

The term “fatty acid” as used herein can refer to a molecule comprising a hydrocarbon chain and a terminal carboxylic acid group. As used herein, the carboxylic acid group of the fatty acid may be modified or esterified, for example as occurs when the fatty acid is incorporated into a glyceride or another molecule (e.g., COOR, where R refers to, for example, a carbon atom). Alternatively, the carboxylic acid group may be in the free fatty acid or salt form (i.e., COO⁻ or COOH). The ‘tail’ or hydrocarbon chain of a fatty acid may also be referred to as a fatty acid chain, fatty acid sidechain, or fatty chain. The hydrocarbon chain of a fatty acid will typically be a saturated or unsaturated aliphatic group. A fatty acid having N number of carbons, will typically have a fatty acid side chain having N−1 carbons. However, the subject application also relates to modified forms of fatty acids, e.g., dimerized fatty acids, and thus the term fatty acid may be used in a context in which the fatty acid has been substituted or otherwise modified as described. For example, in various aspects, a fatty acid may be dimerized with another fatty acid to result in a dimerized fatty acid. Unless otherwise specified, the term fatty acid as used herein refers to a non-dimerized fatty acid, while the term dimerized fatty acid and the like refer to the dimer forms of fatty acids.

An “acylglyceride” refers to a molecule having at least one glycerol moiety with at least one fatty acid residue that is linked via an ester bond. For example, acylglycerides can include monoacylglycerides, diacylglycerides, triacylglycerides and acylglyceride polymers. The group acylglycerides can be further refined by additional descriptive terms and can be modified to expressly exclude or include certain subsets of acylglycerides. For example, the phrase mono- and di-acylglycerides refers to MAGs (monoacylglycerides) and DAGs (diacylglycerides), while the phrase non-MAG/non-DAG acylglycerides refers to a group of acylglycerides which exclude MAGs and DAGs. As another example, acylglycerides comprising a C36 dimeric fatty acid residue refers only to those acylglycerides having the specified residue.

A “fatty acid” is a C8-C22 alkyl chain attached to an acid moiety. Fatty acids may be saturated or unsaturated. Fatty acids may be straight chain or branched and may include substituents such as C1-C3 alkyl groups or hydroxy groups.

A “fatty acid residue” is a fatty acid in its acyl or esterified form.

The levels of particular types of fatty acids may be provided herein in percentages out of the total fatty acid content of an oil. Unless specifically noted otherwise, such percentages are weight percentages based on the total fatty acids, including free fatty acids and esterified fatty acids as calculated experimentally.

A “saturated” fatty acid is a fatty acid that does not contain any carbon-carbon double bonds in the hydrocarbon chain. An “unsaturated” fatty acid contains one or more carbon-carbon double bonds. A “polyunsaturated” fatty acid contains more than one such carbon-carbon double bond while a “monounsaturated” fatty acid contains only one carbon-carbon double bond. Carbon-carbon double bonds may be in one of two stereoconfigurations denoted cis and trans. Naturally-occurring unsaturated fatty acids are generally in the “cis” form.

Non-limiting examples of fatty acids include C8, C10, C12, C14, C16 (e.g., C16:0, C16:1), C18 (e.g., C18:0, C18:1, C18:2, C18:3, C18:4), C20 and C22 fatty acids. For example, the fatty acids can be caprylic (8:0), capric (10:0), lauric (12:0), myristic (14:0), palmitic (16:0), stearic (18:0), isostearic, ricinoleic, oleic (18:1), linoleic (18:2), and linolenic (18:3) acids. In any aspect, the fatty acid can be isostearic acid or stearic.

The fatty acid composition of an oil can be determined by methods well known in the art. The American Oil Chemist's Society (AOCS) maintains analytical methods for a wide variety of tests performed on vegetable oils. Hydrolysis of the oil's components to produce free fatty acids, conversion of the free fatty acids to methyl esters, and analysis by gas-liquid chromatography (GLC) is the universally accepted standard method to determine the fatty acid composition of an oil sample. The AOCS Procedure Ce 1-62 describes the procedure used.

The terms “esterification or esterified” means the creation of an ester bond including: 1) the dehydration reaction of an alcohol with an acid; 2) transesterification, the reaction of an alcohol with an ester to form a new ester; or 3) interesterification, the rearrangement of fatty acids within a triacylglycerol structure.

The term “C2-C6 polyol” means any two to six carbon atom structure that contains more than one hydroxy group. Non-limiting examples of C2-C6 polyols include ethylene glycol, glycerol, butanediol, propanediol, hexanediol, sugar alcohols, sorbitol, and erythritol. In any aspect the C2-C6 polyol can be glycerol.

The terms “fatty acid dimer” and “dimerized fatty acid” are interchangeably used herein and refer generally to a compound containing two fatty acid subunits in which the respective fatty acid side chains are covalently bound to each other, e.g., via a bond or a linking group. Thus, as described herein, the fatty acid dimer is a covalent fatty dimer. The fatty acid dimer can be a heterodimer or a homodimer. As used herein, the carboxylic acid group of the fatty acid dimer may be modified or esterified, for example as occurs when the fatty acid dimer is incorporated into a glyceride or is attached to another molecule. Suitable fatty acid dimers are commercially available, for example, Radiacid 0960 Hydrogenated Standard Dimer and Radiacid 0970 Distilled Dimer Acid (Oleon N.V., Belgium) and UNIDYME 18 Dimer Acid (Kraton Corporation, Houston, TX).

As an example, the dimerized fatty acid residue can have the structure:

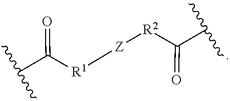

In the example dimerized fatty acid residue, R¹ and R² are each independently a substituted or unsubstituted aliphatic group. The aliphatic group can correspond to a saturated fatty acid side chain or an unsaturated fatty acid side chain having one, two, three or more double bonds. The aliphatic group can be, for example, 5 to 25 carbons, 7 to 21 carbons, 12 to 21 carbons, 15 to 19 carbons, or 17 carbons. Optionally, R¹ and R² can be substituted, and exemplary substituents include alkyl, alcohol, halide, and oxygen so as to form an epoxide ring. R¹ and R² can be a saturated or unsaturated linear aliphatic group having 7, 9, 11, 13, 15, 17, 19 or 21 carbons. When R¹ and R² are each a 17-carbon saturated or unsaturated group, the resulting dimerized fatty acid residue has 36 carbons. R¹ and R² can comprise hydrogen, carbon, oxygen, and nitrogen atoms; or R¹ and R² can consist of carbon, hydrogen, and oxygen atoms; or R¹ and R² can consist of carbon and hydrogen atoms.

The linking group Z is a bond, an oxygen atom, or any other suitable linking group. The linking group Z may be attached to R¹ and R² via any position. For example, the linking group Z may be attached to a position at R¹ and R² other than the terminal carbons. As another example, R¹ and R² can be a linear aliphatic group which corresponds to a fatty acid side chain, and the linking group Z can be attached at omega number 2, 3, 4, 5, 6, 7, 8, 9, 10, 11, 12, 13, 14, 15, 16, 17, etc., or, alternatively the linking group Z can be linked at the terminal (ω−1) carbon. In another example, the Z group represents multiple bonds such that R¹ and R² are linked so as to form a carbocyclic or heterocyclic ring between them. When Z is a bond, the dimerized fatty acid residue may have the structure:

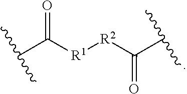

A “plurality” refers to two or more. For example, a polymeric compound having a plurality of glycerol units can have 2 or more glycerol units, 10 or more glycerol units, 100 or more glycerol units, 1,000 or more glycerol units, etc.

A “drop point” or “dropping point” generally refers to the temperature at which a material (such as a wax) softens and becomes sufficiently fluid to flow as determined under the conditions of a given standardized test. As used herein, drop points are determined via AOCS Standard Procedure Cc 18-80. (Official Methods and Recommended Practices of the American Oil Chemists' Society, 7th Edition). Drop point is similar to melting point in that it reflects the thermal characteristics of a compound, however, drop point can be useful in defining materials which do not have a defined melting point.

The term “isosteric acid” as used herein refers to the chemical 16-methylheptadecanoic acid, which is a methyl-branched fatty acid that is heptadecanoic acid substituted by a methyl group at position 16. Isostearic acid is a lightly-branched, liquid fatty acid which can be produced by the reaction of oleic acid with a natural mineral catalyst. Isosteric acid is used in applications which require a liquid fatty acid with stability: thermal stability in the case of a lubricant, odor stability for a cosmetic formulation, and oxidation stability for products with long shelf-life requirements. The branching structure of isostearic acid also enhances its dispersing power, and it is used in cosmetic and industrial applications for the stabilization of pigments and mineral particles in oils and solvents. Isosteric acid is well known and commercially available. As used here in the term isosteric acid refers to a composition that comprises substantially all isosteric acid but need not be 100% pure.

The term “Polydispersity Index” (also known as “Molecular Weight Distribution”) as used herein is the ratio of weight average molecular weight (Mw) to number average molecular weight (Mn). The polydispersity data is collected using a Gel Permeation Chromatography instrument equipped with a Waters 510 pump and a 410 differential refractometer. Samples are prepared at an approximate 2% concentration in a THF solvent. A flow rate of 1 ml/minute and a temperature of 35° C. are used. The columns consist of a Phenogel 5 micron linear/mixed Guard column, and 300×7.8 mm Phenogel 5 micron columns (styrene-divinylbenzene copolymer) at 50, 100, 1000, and 10000 Angstroms. Molecular weights were determined using the following standards:

| Standard | Mono-olein | Diolein | Arcol LHT 240 | Trio-lein |
|---|---|---|---|---|
| Mol. | 356 | 620 | 707 | 878 |
| Weight | | | | |
| (Daltons) | | | | |
| Standard | Epoxidized | Acclaim | Mult-ranol | Acclaim |
| | Soybean Oil | 2200 | 3400 | 8200 |
| Mol. | 950 | 2000 | 3000 | 8000 |
| Weight | | | | |
| (Daltons) | | | | |

The term “weight average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using the test described herein or through size exclusion chromatography, light scattering, small angle neutron scattering, X-ray scattering, and sedimentation velocity.

The term “number average molecular weight” as used herein refers to Mₙ, which is equal to the total weight of the sample divided by the number of molecules in the sample. Mₙ, can be represented by the formula ΣMᵢnᵢ/nᵢ, where nᵢ is the number of molecules of molecular weight Mᵢ.

The term “Acid Value” (AV) as used herein is defined as the weight of KOH in mg needed to neutralize the organic acids present in 1 g of test sample and it is a measure of the free fatty acids present in the composition. AV can be determined by the AOCS Official Method Cd 3d-63. The acid value of the compositions described herein may be less than 20.0, or less than 10.0, or less than 4.0, or between 0.5 and 5.0, or between 0.5 and 4.0.

The term “Hydroxyl Value” as used herein is defined as the hydroxyl value, expressed in milligrams of potassium hydroxide and corresponds to the number of hydroxyl groups present in 1 g of a sample, is one of the traditional characteristics of oils and fats. Hydroxyl Value may be determined by AOCS Standard Method Cd 13-60.

The term “Iodine Value” (commonly abbreviated as IV) as used herein is the mass of iodine in grams that is consumed by 100 grams of a chemical substance. Iodine numbers are often used to determine the amount of unsaturation in fats, oils and waxes. In fatty acids, unsaturation occurs mainly as double bonds which are very reactive towards halogens, iodine in this case. Thus, the higher the iodine value, the more unsaturation is present in the sample. The Iodine Value of a material can be determined by the standard well-known Wijs method (A.O.C.S. Cd1-25).

### Wax Formulation

The formulation provided herein is useful in the manufacture of wax formulations such as candle wax or other wax products. The inventors unexpectedly found that wax formulations comprising a natural oil-based petrolatum have numerous desirable characteristics as explained further below and can be used to replace all or part of the petroleum based petrolatum currently used in wax formulations.

In one aspect, the present disclosure provides a wax formulation that includes about 5 wt % to about 85 wt % of a natural oil-based petrolatum composition based on total weight of the wax formulation; and about 1 wt % to about 95 wt % of a wax material based on total weight of the wax formulation; wherein the natural oil-based petrolatum composition includes an esterification product of a pre-esterification mixture that includes: about 0.1 wt % to about 40 wt % a fatty acid dimer based on total weight of the pre-esterification mixture, about 99.9 wt % to about 60 wt % of one or more components selected from the group consisting of C2-C6 polyols, natural oils, hydrogenated natural oils, fatty acids, and acyl glycerols, based on total weight of the pre-esterification mixture, wherein the natural oil-based petrolatum composition has a cone penetration value of greater than 10 and polydispersity index greater than 1.3.

In any aspect, the wax formulation as described herein includes about 5 wt % to about 85 wt % of the natural oil-based petrolatum composition, based on total weight of the wax formulation. For example, the natural oil-based petrolatum composition may be present in the wax formulation in amounts of about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or any range including and/or in between any two of the preceding values. In any aspect, the wax formulation may include the natural oil-based petrolatum composition in an amount of about 5 wt % to about 85 wt %, about 15 wt % to about 85 wt %, about 20 wt % to about 85 wt %, about 20 wt % to about 80 wt %, about 25 wt % to about 75 wt %, about 10 wt % to about 60 wt %, about 15 wt % to about 50 wt %, about 18 wt % to about 28 wt %, or any range including and/or in between any two of the preceding values.

The natural oil-based petrolatum composition described herein has a unique composition which provides a more consistent rheology over a variety of temperatures more closely mimicking petroleum-based petrolatum.

In any aspect, the hydrogenated natural oil is hydrogenated soy, palm, canola, caster, or coconut oil.

In any aspect, the hydrogenated natural oil is hydrogenated soy oil, coconut, or castor oil.

In any aspect, the fatty acid dimer is, Radiacid 0960 Hydrogenated Standard Dimer and Radiacid 0970 Distilled Dimer Acid (Oleon N.V., Belgium) and UNIDYME 18 Dimer Acid (Kraton Corporation, Houston, TX).

In any aspect, the fatty acid dimer may be Radiacid 0970. The natural oil-based petrolatum composition may include minimal amounts of free fatty acids. For example, the natural oil-based petrolatum composition may include less than about 2 wt % free fatty acids. In another aspect, the natural oil-based petrolatum composition may include less than about 1 wt %, about 2.5 wt %, less than about 5 wt %, or less than about 10 wt %, free fatty acids, and triacylglycerides.

In any aspect, the acylglyceride polymer having at least two dimer structures is represented to by following: wherein R³ is hydrogen, glycerol, a substituted glycerol, or a fatty acid and n is one or greater.

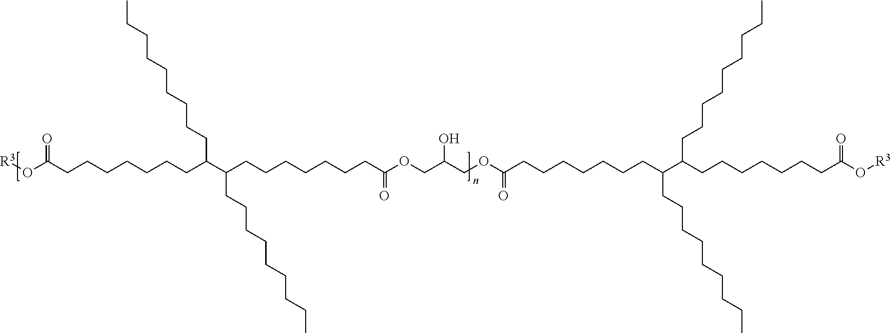

The natural oil-based pertrolatum composition may include about 5.0 wt. % to about 50 wt. % of acylglyceride polymers having at least two dimer structures. Alternatively, the natural oil-based composition may include greater than 10% or about 5.0 wt. % to about 50 wt. % of acylglyceride polymers having at least two dimer structures.

The natural oil-based petrolatum composition included in the wax formulation can further be described in terms of average molecular weight distribution, which may be determined by gel permeation chromatography (GPC).

The natural based-petrolatum composition, as described herein in any aspect, may include one or more of the following: i) an acid value of less than about 20.0; ii) a polydispersity index of greater than about 1.3; or iii) an iodine value of less than about 10.0.

The acid value as described herein in any aspect may be about 5 to about 20.0, or about 10 to about 20.

The iodine value of the compositions described herein may be less than about 10.0, or less than about 8.0, or in between about 4.0 to about 10. Suitable iodine values as described herein in any aspect may include about 0.5, about 1.0, about 1.5, about 2.0, about 2.5, about 3.0, about 3.5, about 4.0, about 4.5, about 5.5, about 6.0, about 6.5, about 7.0, about 7.5, about 8.0, about 8.5, about 9.0, about 9.5, about 10.0, or any range including and/or in between any two of the preceding values. For example, the iodine value may be about 0.5 to about 5.0, about 0.5 to about 4.5, about 1.0 to about 4.5, or about 2.5 to about 4.5.

The polydispersity index (PDI) of the composition, as described herein in any aspect, may be greater than about 1.3. For example, the natural oil-based petrolatum composition may have a PDI of about 1.3 to about 2.0 or from about 1.3 to 1.7.

Unlike waxes or hard fats, the natural-based petrolatum composition as described herein can be a semisolid material that can hold its own shape but deflects under pressure more similar to a grease or shortening. Resistance to deflection under pressure can be determined through use of a cone penetration test. Cone penetration can be measured by use of standard methodology ASTM D217-2. The natural-based petrolatum composition described herein can have a cone penetration at 25° C. of greater than 10, or from about 10 to about 250 or from about 50 to about 100 (Dmm (1/10 of mm).

The natural-based petrolatum composition exhibits a combination of rheological properties that provides for comparable spreading and tackiness to petroleum-based petrolatum. In any aspect disclosed herein, the natural-based petrolatum composition exhibits one or more rheological properties selected from a drop point of about 30° C. to about 60° C., a cone penetration at 25° C. of greater than 20 or from about 20 to about 250 or from about 60 to about 200 (Dmm (1/10 of mm), kinetic viscosity at 100° C. of about 5 mm²/s to about 60 mm²/s, a congealing point of about 25° C. to about 45° C., or combinations thereof.

The natural oil-based petrolatum composition can be prepared according to a method that includes mixing a fatty acid, a hydrogenated natural oil, a fatty acid dimer, and glycerin. The resulting mixture is treated with an esterification catalyst which induces esterification and transesterification. The reaction is allowed to proceed until the reaction mixture reaches an acid value of less than 5.0 or until the reaction mixtures reaches an acid value of less 4.0 so as to provide a natural oil-based petrolatum composition. In any aspect, that reaction mixture reaches an acid value between 0.5 and 4.0. In any aspect, that reaction mixture reaches an acid value between 0.5 and 3.5.

The natural oil can be a vegetable oil or an animal oil. Examples of oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, castor oil, lard, tallow, poultry fat, yellow grease, fish oil, or mixtures thereof.

In any aspect, the fatty acid dimer has the structure

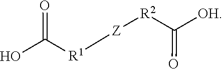

R¹ and R² are each independently defined divalent fatty acid chains so that R¹ and R² may be the same or different. When R¹ and R² are the same, the dimerized fatty acid represents a fatty acid homodimer. When R¹ and R² are the different, the dimerized fatty acid represents a fatty acid heterodimer. In any aspect, each of R¹ and R² is independently a substituted or unsubstituted C7-C21 aliphatic group corresponding to a saturated chain or an unsaturated fatty acid side chain having one, two, three or more double bonds. R¹ and R² can represent substituted forms of the side chains of naturally occurring fatty acids. For example, R¹ and R² may each independent be a saturated or unsaturated linear aliphatic group having 7, 9, 11, 13, 15, 17, 19 or 21 carbons. When R¹ and R² are each a 17-carbon saturated or unsaturated group, the resulting dimerized fatty acid has 36 carbons. R¹ and R² can comprise hydrogen, carbon, oxygen, and nitrogen atoms; or R¹ and R² can consist of carbon, hydrogen, and oxygen atoms; or R¹ and R² can consist of carbon and hydrogen atoms.

The linking group Z is a bond, an oxygen atom, or a sulfur atom. The linking group Z may be attached to R¹ and R² via any position. When Z is a bond, the dimerized fatty acid may have the structure:

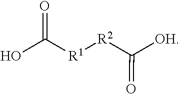

Non-limiting examples of dimerized fatty acids include those commercially available as Radiacid 0960 Hydrogenated Standard Dimer and Radiacid 0970 Distilled Dimer Acid (Oleon N.V., Belgium) and UNIDYME 18 Dimer Acid (Kraton Corporation, Houston, TX). The dimerized fatty acid may be derived from a natural oil. As another example, a T18 dimer acid can be used. Radiacid 0960 Distilled Dimer Acid (Oleon N.V., Belgium) as used herein was analyzed to contain 1.6% monomer, 79.22% dimer, 14.99% trimer, and 4.19% tetramer or higher.

In contrast to a simple blend of a few ingredients, the natural oil-based petrolatum compositions disclosed herein more closely mimic petroleum-based petrolatum by containing a complex mixture of components with differing molecular weights and rheological properties. Creating such a product by blending would be exhaustively time consuming and costly. The elegant esterification process disclosed herein utilizing a fatty acid dimer and a variety of components allows for the creation of a natural based petrolatum mimetic.

The method of making the natural oil-based petrolatum composition as described herein may include preparing a reaction mixture that includes one or more components selected from the group consisting of C2-C6 polyols, natural oils, hydrogenated natural oils, fatty acids, and acyl glycerols and fatty acid dimer by pre-melting and heating to a temperature ranging from 60-80° C. before adding to a reaction vessel along with a nitrogen sparge to prevent oxidation.

The reaction mixture has the composition as described herein and the mixture is treated to induce chemical or enzymatic transesterification and esterification by methods well known in the art.

To carry out chemical transesterification, a catalyst can be added at an amount of about 0.1 wt % relative to the reaction mixture. Example catalysts can be potassium hydroxide or calcium hydroxide. The reaction temperature can then be increased to about 200-250° C. This reaction temperature is maintained until an acid value of less than 5 is achieved or a polydispersity index of greater than 1.3 is obtained. An acid, for example a mineral acid such as phosphoric acid, can be added at an amount of about 0.2 wt % to neutralize the catalyst with a slight excess. The reaction mixture can then be cooled to a temperature ranging from about 60-80° C. A filter media, for example acid activated beaching clay, can be added to the reaction mixture in an amount of about 2 wt % relative to the reaction mixture to remove impurities. The final product, i.e., the natural oil-based petrolatum composition, is then filtered to remove the salt and clay mixture.

Alternatively, to carry out enzymatic transesterification, an enzymatic catalyst can be added at an amount of 2 wt % relative to the reaction mixture. An example enzymatic catalyst can be Lipase Novozyme 435. A vacuum of about 50 torr can be used to remove water as the reaction is taking place. A reaction temperature ranging from about 60-80° C. is maintained until an acid value of less than 5.0 is achieved or a polydispersity index of greater than 1.3 is obtained. The enzymatic catalyst can then be filtered out using an appropriate filter device to obtain the final product, i.e., the natural oil-based petrolatum composition.

Alternatively, to carry out an acid catalyzed transesterification, components (excluding dimer and catalyst) are preferably pre-melted and heated to 110° C. before adding to the reaction vessel. The dimer can then be added to the reaction vessel under a nitrogen sparge to help prevent the introduction of oxygen, yielding a starting temperature of 60-70° C. An acid catalyst can be added to facilitate the reaction. A skilled artisan would appreciate a wide variety of catalysts may be used in this type of reaction. In any aspect, the catalyst may be (methanesulfonic acid (MSA)) and/or HPPA (hypophosphorous acid, 50% in water). Catalyst is typically utilized in an amount of 0.1-0.2% based on the mass of the reaction components. The reaction is then agitated and heated to an elevated temperature. The rate of the reaction will depend on temperature so an elevated temperature may be desired, however, at too high of a reaction temperature degradation and undesired side products can be prepared as well. In any aspect, the reaction temperature is 140° C. to 180° C. In other aspects the reaction temperature is about 160° C. The reaction temperature is maintained until an acid value of 2 or less was achieved and the melting point and molecular weight distribution have stabilized. Reduced pressure by vacuum may be applied to accelerate or complete the reaction. The reaction mixture can be allowed to cool to approximately 80° C. to 90° C. before a base is added to neutralize any residual acids. In any aspect, the base is solid calcium hydroxide. The base can be added in any amount sufficient to perform the neutralization. The reaction product can be isolated or alternatively, a silica gel such as TRISYL, can be added to the reaction at approximately 1% to bleach and absorb polar impurities. The product can then be filtered to remove the salts and the silica mixture as well as other impurities. Formulations prepared using the natural oil-based petrolatum composition disclosed herein have a white or pale white color that is generally considered to be aesthetically appealing. In some cases, the formulations of this disclosure may be further processed to make a colored end product. In such cases, the white color is beneficial because it will show up the additional pigment without influencing the final color.

In any aspect, the wax formulation as described herein includes about 1 wt % to about 95 wt % of the wax material, based on total weight of the wax formulation. For example, the wax material may be present in the wax formulation in amounts of about 1 wt %, about 2.5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or any range including and/or in between any two of the preceding values. In any aspect, the wax formulation may include the wax material in an amount of about 2.5 wt % to about 90 wt %, about 5 wt % to about 80 wt %, about 10 wt % to about 65 wt %, about 15 wt % to about 55 wt %, about 25 wt % to about 95 wt %, about 35 wt % to about 90 wt %, or about 50 wt % to about 85 wt %.

The wax material may be any prior art wax known to those of skill in the art. For example, suitable wax materials may include, but are not limited to, creature waxes (such as beeswax), petroleum-based waxes (such as paraffin wax), plant-based waxes, natural oil-based waxes, or mixtures thereof. In any aspect, the wax material may include beeswax, paraffin wax, natural oil-based waxes, or mixtures thereof. In any aspect, the wax material may be a natural oil-based wax. The natural oil-based wax may be a flexible wax composition. In any aspect, the wax material may be a flexible wax, wherein the flexible wax includes about 20 wt % to about 45 wt % monoacylglycerides, about 28 wt % to about 40 wt % diacylglycerides, and about 10 wt % to about 45 wt % acylglyceride polymers, wherein the acylglyceride polymers are compounds containing one or more dimerized fatty acid residue and a plurality of glycerol moieties. In any aspect, the flexible wax composition may include about 40 wt % to about 75 wt % monoacylglycerides and diacylglycerides having a weight average molecular weight of about 200 Da to about 580 Da, and at least 10 wt % acylglycerides having a weight average molecular weight of about 900 Da to about 3000 Da. Suitable flexible wax compositions for use in the present wax formulations are described in U.S. Patent Application Publication No. 2021/0062003 entitled “FLEXIBLE WAX AND METHOD OF MAKING THE SAME,” filed Jan. 14, 2019, the entire contents of which are hereby incorporated by reference. Suitable natural oil-based waxes for use in the present wax formulations are further described in U.S. Pat. No. 7,217,301, entitled “TRIACYLGLYCEROL-BASED ALTERNATIVE TO PARAFFIN WAX,” filed Sep. 5, 2003, and U.S. Pat. No. 11,008,532, entitled “WAX COMPOSITIONS AND THE EFFECT OF METALS ON BURN RATES,” their entire contents of which are hereby incorporated by reference.

The wax material may further include creature waxes such as lanolin, shellac wax, Chinese insect wax, and spermaceti, various types of plant waxes such as carnauba, candelilla, Japan wax, ouricury wax, rice-bran wax, jojoba wax, castor wax, bayberry wax, sugar cane wax, and maize wax, and synthetic waxes such as polyethylene wax, Fischer-Tropsch wax, chlorinated naphthalene wax, chemically modified wax, substituted wax, montan wax, alpha olefins and polymerized olefin wax.

The wax formulation of the present technology exhibits a melt point in the range of about 100° F. (˜37.8° C.) to about 150° F. (˜65.6° C.), or preferably about 110° F. (˜43.3° C.) to about 140° F. (60° C.). For example, the wax formulation may exhibit a melt point of about 100° F. (˜37.8° C.), about 105° F. (˜40.6° C.), about 110° F. (˜43.3° C.), about 115° F. (˜46.1° C.), about 120° F. (˜48.9° C.), about 125° F. (˜51.7° C.), about 130° F. (˜54.4° C.), about 135° F. (˜57.2° C.), about 140° F. (60° C.), about 145° F. (˜62.8° C.), about 150° F. (˜65.6° C.), or any range including and/or in between any two of the preceding values.

The wax formulation may further include one or more natural oils as described herein. For example, the wax formulation may include about 0 wt % to about 85 wt % of the natural oil based on total weight of the wax formulation. Suitable amounts of the natural oils may include about 5 wt % to about 85 wt %, about 20 wt % to about 80 wt %, about 25 wt % to about 75 wt %, about 25 wt % to about 55 wt %, or any range including and/or in between any two of the preceding values. In any aspect, the natural oils present in the wax formulation may be interesterified natural oils, hydrogenated natural oils, or combinations thereof. In any aspect, the natural oils present in the wax formulation may be interesterified natural oils (e.g., interesterified coconut oil, interesterified soybean oil, interesterified canola oil, interesterified palm oil, interesterified rapeseed oil, or mixtures of any two or more thereof).

The wax formulation, when formulated for use in candle wax or other wax products containing scenting agents, surprisingly exhibit improved fragrance throw. As used herein, the term “fragrance throw” or “scent throw” refers to the release of aroma from a wax product (e.g., candles) containing scenting agents. Generally, the terms “fragrance throw” or “scent throw” encompass both hot throw (i.e., release of aroma when the candle is burning) and cold throw (i.e., release of aroma when the candle is not lit or heated).

The wax formulation, when formulated for use in candle wax or other wax products, also has the proper surface adhesion characteristics so the wax does not pull away from the container when cooled. The wax formulation may also exhibit reduced or no cracking when formulated for use in candle wax or other wax products. Additionally, the present wax formulation may provide a consistent, even appearance when resolidified and does not exhibit undesirable mottling in the candle which results from uneven wax crystallization.

In an aspect, the present disclosure also provides a method for preparing a wax formulation as described herein, the method includes:
heating a wax material to a temperature wherein the wax material is in a molten state; and
combining the wax material in a molten state with a natural oil-based petrolatum composition;
wherein the natural oil-based petrolatum composition includes an esterification product of a pre-esterification mixture that includes:
   about 0.1 wt % to about 40 wt % of a fatty acid dimer based on total weight of the natural oil-based petrolatum composition,
   about 99.9 wt % to about 60 wt % of one or more components selected from the group consisting of C2-C6 polyols, natural oils, hydrogenated natural oils, fatty acids, and acyl glycerols, based on total weight of the natural oil-based petrolatum composition,
   wherein the natural oil-based petrolatum composition has a cone penetration value of greater than 10 and a polydispersity index of greater than 1.3.

In an additional aspect, the present disclosure provides a wax formulation prepared according to the method as described herein.

### Compositions

The wax formulations of the present disclosure can be utilized in the preparation of various compositions (e.g., candle wax or other wax products).

In an aspect, the present disclosure provides a candle wax composition that includes a wax formulation as described herein. The wax formulation includes about 5 weight percent (wt %) to about 75 wt % of a natural oil-based petrolatum composition based on total weight of the wax formulation; and about 25 wt % to about 95 wt % of a wax material based on total weight of the wax formulation; wherein the natural oil-based petrolatum composition that includes an esterification product of a pre-esterification mixture that includes: about 0.1 wt % to about 40 wt % a fatty acid dimer based on total weight of the pre-esterification mixture, about 99.9 wt % to about 60 wt % of one or more components selected from the group consisting of C2-C6 polyols, natural oils, hydrogenated natural oils, fatty acids, and acyl glycerols, based on total weight of the pre-esterification mixture, wherein the natural oil-based petrolatum composition has a cone penetration value of greater than 10 and a polydispersity index greater than 1.3.

The candle wax composition may include about 1 wt % to 100 wt % of the wax formulation based on total weight of the candle wax composition. Preferably, the candle wax composition may include about 5-70 wt %, about 50-99%, about 75-95%, about 20-90%, about 20-80%, about 1-30%, about 2-20%, or about 1-15% of the wax formulation based on total weight of the candle wax composition. Suitable amounts of the wax formulation present in the candle wax composition may include about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 99 wt %, 100 wt %, or any range including and/or in between any two of the preceding values.

Candle wax compositions containing the wax formulation of the present disclosure may optionally contain additional ingredients to tailor the needs of the particular application. A skilled artisan will readily appreciate the range of additives available to suit this purpose including but not limited to the following: wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

A skilled artisan would appreciate that one or more additives as described herein may be present in various concentrations depending on the needs of the particular candle wax composition. In any aspect, the candle wax composition may include about 0.1 wt % to about 30 wt % of the one or more additives based on total weight of the candle wax composition. For example, the one or more additives may be included in the candle wax composition in amounts of about 0.1 wt %, about 0.5 wt %, about 1 wt %, about 5 wt %, about 10 wt %, about 15 wt %, about 20 wt %, about 25 wt %, about 30 wt %, or any range including and/or in between any two of the preceding values.

Suitable wax-fusion enhancing additives may include, but are not limited to, benzyl benzoate, dimethyl phthalate, dimethyl adipate, isobornyl acetate, cellulose acetate, glucose pentaacetate, pentaerythritol tetraacetate, trimethyl-s-trioxane, N-methylpyrrolidone, polyethylene glycols and mixtures thereof. Typically, the candle wax composition may include about 0.1 wt % to about 5 wt % of the wax-fusion enhancing additive based on total weight of the candle wax composition.

Suitable coloring agents (i.e., dyes or pigments) may be included in the candle wax composition in amounts of about 0.001 wt % to about 2 wt % based on total weight of the composition. For example, the coloring agent may be present in amounts of about 0.001 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, or any range including and/or in between any two of the preceding values. The coloring agents may be added to the candle wax composition to provide a desired hue to the composition. If a pigment is employed as a coloring agent, it is typically an organic toner in the form of a fine powder suspended in a liquid medium, such as a mineral oil. It may be advantageous to use a pigment that is in the form of fine particles suspended in a natural oil as described herein. Coloring agents suitable for use in candle wax compositions are known to those of skill in the art. For example, a variety of pigments and dyes suitable for use in the candle wax composition of the present technology are described in U.S. Pat. No. 4,614,625, the entire contents of which are hereby incorporated by reference. In any aspect, the carrier for use with organic dyes is an organic solvent, such as a relatively low molecular weight, aromatic hydrocarbon solvent (e.g., toluene and xylene).

Suitable scenting agent additives may include one or more perfumes, fragrances, essences, or other aromatic oils which may be added to provide a desired aroma or odor to the candle wax composition. For example, the scenting agent may include, but is not limited to, air fresheners, insect repellents, or mixtures thereof. In any aspect, the air freshener may be a liquid fragrance that includes one or more volatile organic compounds, including those commercially available from perfumery suppliers such as: IFF, Firmenich Inc., Takasago Inc., Belmay, Symrise Inc., Noville Inc., Quest Co., and Givaudan-Roure Corp. Most conventional fragrance materials are volatile essential oils. The fragrance can be a synthetically formed material, or a naturally derived oil such as oil of bergamot, bitter orange, lemon, mandarin, caraway, cedar leaf, clove leaf, cedar wood, geranium, lavender, orange, origanum, petitgrain, white cedar, patchouli, lavandin, neroli, rose, and the like. The scenting agent can also be a liquid formulation containing an insect repellent such as citronellal, or a therapeutic agent such as eucalyptus or methanol.

Additionally or alternatively, in any aspect described herein the scenting agent may be selected from a wide variety of chemicals including, but not limited to, aldehydes, ketones, esters, alcohols, terpenes, and the like. The scenting agent can be relatively simple in composition, or can be a complex mixture of natural and synthetic chemical components. The scenting agent may include scented oils. A typical scented oil may include woody/earthy bases containing exotic constituents such as sandalwood oil, civet, patchouli oil, and the like. A scented oil can have a light floral fragrance such as rose extract or violet extract. Scented oil also can be formulated to provide desirable fruity odors, such as lime, lemon, or orange.

The scenting agent may include a synthetic type of fragrance composition either alone or in combination with natural oils such as described in U.S. Pat. Nos. 4,314,915; 4,411,829; and 4,434,306; their entire contents of which are hereby incorporated by reference. Other suitable scenting agents may include artificial liquid fragrances including, but not limited to, geraniol, geranyl acetate, eugenol, isoeugenol, linalool, linalyl acetate, phenethyl alcohol, methyl ethyl ketone, methylionone, isobornyl acetate, and the like.

In any aspect, the candle wax composition of the present technology containing a scenting agent as described herein may further exhibit improved fragrance throw.

In any aspect, a “migration inhibitor” additive may be included in the candle wax composition to decrease the tendency of colorants, fragrance components, and/or other components of the candle wax composition from migrating to the outer surface of a candle. For example, the migration inhibitor may be a polymerized alpha olefin. In any aspect, the polymerized alpha olefin has at least 10 carbon atoms. In any aspect, the polymerized alpha olefin may have between 10 and 25 carbon atoms. For example, one suitable polymer is a hyper-branched alpha olefin polymer sold under the trade name Vybar® 103 polymer (mp 168° F.; ˜76° C.); commercially available form Baker-Petrolite, Sugarland, TX, USA).

Other suitable migration inhibitor additives may include sorbitan triesters, such as sorbitan tristearate and/or sorbitan tripalmitate, and related sorbitan triesters formed from mixtures of fully hydrogenated fatty acids, and/or polysorbate triesters or monoesters such as polysorbate tristearate and/or polysorbate tripalmitate and related polysorbates formed from mixtures of fully hydrogenated fatty acids in the candle wax composition may also decrease its chances of cracking during the cooling processes that occur in candle formation and after extinguishing the flame of a burning candle.

In any aspect, the candle wax composition may include about 0.1 wt % to about 5 wt % of the migration inhibitor based on total weight of the candle wax composition. Preferably, the migration inhibitor additive may be present in an amount of about 0.1 wt % to about 2 wt %.

In any aspect, the candle wax composition may include an additional optimal wax ingredient, including but not limited to, creature waxes such as beeswax, lanolin, shellac wax, Chinese insect wax, and spermaceti, various types of plant waxes such as carnauba, candelilla, Japan wax, ouricury wax, rice-bran wax, jojoba wax, castor wax, bayberry wax, sugar cane wax, and maize wax, and synthetic waxes such as polyethylene wax, Fischer-Tropsch wax, chlorinated naphthalene wax, chemically modified wax, substituted wax, montan wax, alpha olefins and polymerized olefin wax. In any aspect, the candle wax composition may include about 1 wt % to about 25 wt %, or preferably 1 wt % to about 10 wt %, of the optimal wax ingredient additive.

In any aspect, the candle wax composition may include about 1 wt % to about 15 wt % of the scenting agent based on total weight of the candle wax composition. For example, the scenting agent may be present in amounts of about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, or any range including and/or in between any two of the preceding values. The coloring and scenting agents generally may also include liquid carriers that vary depending upon the type of color- or scent-imparting ingredient employed. In any aspect, the use of liquid organic carriers with coloring and scenting agents is preferred because such carriers are compatible with petroleum-based waxes and related organic materials. As a result, such coloring and scenting agents tend to be readily absorbed into the candle wax composition.

The candle wax composition may include a surfactant. In any aspect, the candle wax composition may include about 1 wt % to about 25 wt %, or preferably about 1 wt % to about 10 wt %, of the surfactant based on total weight of the candle wax composition. Suitable surfactants for use in the candle wax composition may include, but are not limited to, polyoxyethylene sorbitan trioleate, such as Tween 85, commercially available form Acros Organics; polyoxyehtylene sorbitan monooleate, such as Tween 80, commercially available from Acros Organics and Uniqema; sorbitan tristearate, such as DurTan65, commercially available form Loders Croklann, Grindsted STS 30 K commercially available from Danisco, and Tween 65 commercially available from Acros Organics and Uniqema; sorbitan monostearate, such as Tween 60 commercially available from Acros Organics and Uniqema, DurTan 60 commercially available from Danisco; Polyoxyethylene sorbitan monopalmitate, such as Tween 40, commercially available from Acros Organics and Uniqema; and polyoxyethylene sorbitan monolaurate, such as Tween 20, commercially available from Acros Organics and Uniqema.

Additionally, the candle wax composition may include a co-surfactant, which may be added, for example, to improve the microstructure (texture) and/or stability (shelf-life) of emulsified wax compositions. In any aspect, the candle wax composition may include about 0.1 wt % to about 5 wt % of the co-surfactant based on total weight of the candle wax composition. The candle wax composition may optionally include an emulsifier. Emulsifiers for waxes are commonly synthesized using a base-catalyzed process, after which the emulsifiers may be neutralized. In any aspect, the emulsifier may be neutralized by adding organic acids, inorganic acids, or combinations thereof to the emulsifier. Non-limiting examples of organic or inorganic acids include citric acid, phosphoric acid, hydrochloric acid, nitric acid, sulfuric acid, lactic acid, oxalic acid, carboxylic acid, as well as other phosphates, nitrates, sulfates, chlorides, iodides, nitrides, and combinations thereof.

In another aspect, the present technology provides a candle that includes a wick in a candle wax composition as described herein. The candle may be in any desired shape. Depending on the type of candle being produced, the candle may be unmolded or used as a candle while still in the mold. Examples of the latter include votive candles and decorative candles, such as those designed to be burned in a clear glass container. The candle may optionally include one or more additives as described herein.

Candles can be produced from the candle wax composition using a number of methods. In one common process, the candle wax composition is heated to a molten state. If additives as described herein (e.g., colorants and/or scenting agents) are in included in the candle formulation, these may be added to the molten candle wax composition or mixed with the wax formulation prior to heating. The molten candle wax composition is then commonly solidified around a wick. When the candle wax composition of the present technology is used as a candle, the same standard wicks that are used with other waxes can be utilized. For example, the molten candle wax composition can be poured into a mold which includes a wick disposed therein. The molten candle wax composition is then cooled to solidify the wax in the shape of the mold. Depending on the type of candle being produced, the candled may be unmolded or used as a candle while still in the mold. Other methods for producing a candle are known to those of skill in the art. For example, suitable methods for producing candles of the present technology are described in U.S. Pat. No. 11,008,532, entitled “WAX COMPOSITIONS AND THE EFFECT OF METALS ON BURN RATES,” their entire contents of which are hereby incorporated by reference.

The present disclosure, thus generally described, will be understood more readily by reference to the following examples, which are provided by way of illustration and are not intended to be limiting of the present invention.

### EXAMPLES

TABLE 1

| Materials | Source |
|---|---|
| Radiacid 0970 Distilled Dimer Acid | Kraton Corporation, |
| (Oleon N.V., Belgium | Houston, TX |
| Isostearic acid (PRIPOL 1006) | Croda Incorporated |
| Stearic Acid (TRV 1665 and TRV 1890) | Twin Rivers Technologies |
| Fully Hydrogenated Soybean Oil | Cargill Incorporated S-155 |
| Fully Hydrogenated Coconut Oil | Cargill Incorporated. Regal |
| | 92 |
| Fully Hydrogenated Castor Oil | Acme Hardesty |
| Glycerol | Cargill Incorporated |

### Example 1

The following chemical transesterification method was carried out to make Samples from Tables 2-4. All components (including dimer) and other components as described in Tables 2-4 were pre-melted and heated to 70° C. before adding to the reaction vessel under a nitrogen sparge to keep the product from oxidizing during the reaction. The agitator was turned on to mix the contents. A caustic catalyst was added (Potassium Hydroxide (KOH) or Calcium Hydroxide (Ca(OH)₂)) at 0.1% dosage. Once all ingredients were added and well mixed the temperature was increased to 200° C. to 250° C. The reaction temperature was maintained until an acid value of 10 or less was achieved. An acid, Phosphoric Acid (85% concentration), was added at 0.2% to neutralize the catalyst with a slight excess. The mixture was cooled to 70° C. and an acid activated bleach clay, B80, was added to the reaction at 2% and allowed to absorb the salts from the catalyst. The product was then filtered to remove the salts and clay mixture as well as other impurities.

TABLE 2

| Examples | | |
|---|---|---|
| Components by Weight | A1 | A2 |
| Fatty acid dimer (T18 Dimer) | 15% | 15% |
| Isosteric Acid | 10% | 15% |
| Fully Hydro Caster oil | 75% | 70% |
| Drop melting Point (° C.) | | 58.3 |
| Cone Penetration at 25° C. | | 207.7 |
| Kinetic Viscosity at 100° C. | | 56.25 |
| (mm2/s) | | |
| Lovibond Color 5 ¼ Ly/Lr | | 54.0/11.8 |
| Congealing point (° C.) | | 34.4 |
| Hydroxyl Value | | 70.2 |
| Acid value | 15.8 | 17.74 |
| Iodine Value | | 5.128 |
| TGA | | |
| Mn/Mw (Da) | | 1663/2261 |
| PDI | | 1.3595911 |

TABLE 3

| Examples | | |
|---|---|---|
| Components by Weight | B1 | B2 |
| Fatty acid dimer (T18 Dimer) | 25% | 30% |
| Isosteric Acid | 25% | 30% |
| Fully Hydro Soy | 35% | 25% |
| Glycerol | 15% | 15% |
| Drop melting Point (° C.) | 47.2 | 38.9 |
| Cone Penetration at 25° C. | 81.5 Dmm | |
| Kinetic Viscosity at 100° C. | 28.75 | |
| (mm2/s) | | |
| Lovibond Color 5 ¼ Ly/Lr | 8.5/2.7 | |
| Congealing point (° C.) | 34.9 | |
| Hydroxyl Value | 143.9 | 131 |
| Acid value | 3.71 | 4.7 |
| Iodine Value | 3.58 | |
| TGA | | |
| Mn/Mw (Da) | 916/1382 | 967/1584 |
| PDI | 1.508 | 1.638 |

TABLE 4
Examples

| Components by Weight | C1 |
|---|---|
| Fatty acid dimer (T18 Dimer) | 20% |
| Fully Hydro Coconut Oil | 15% |
| Fully Hydro Soy Oil | 45% |
| Glycerin | 20% |
| Drop melting Point (° C.) | 37.2 |
| Cone Penetration at 25° C. | 51 Dmm |
| Kinetic Viscosity at 100° C. | 18.75 |
| (mm²/s) | |
| Lovibond Color 5 ¼ Ly/Lr | 12.0/2.7 |
| Congealing point (° C.) | 28.5 |
| Hydroxyl Value | 304.4 |
| Acid value | 0.98 |
| Iodine Value | 4.5 |
| TGA | |
| Mn/Mw (Da) | 712/1020 |
| PDI | 1.433 |

### Example 2

The following chemical transesterification method was carried out to make Samples A3-A7 in Table 5. Components (excluding dimer) were pre-melted and heated to 110° C. before adding to the reaction vessel. The dimer was then added to the reaction vessel under a nitrogen sparge, yielding a starting temperature of 60-70° C. An acid catalyst (methanesulfonic acid (MSA)) and HPPA (hypophosphorous acid, 50% in water) were added at 0.1% dosage each based on the mass of the reactants. The agitator was turned on to mix the contents. Once all ingredients were added and well mixed the temperature was increased to 160° C. The reaction temperature was maintained until an acid value of 2 or less was achieved and the melting point and molecular weight distribution stabilized. The mixture was allowed to cool to 85° C. before solid calcium hydroxide was added at 0.16% based on the total mass of the reactants. A silica gel, TRISYL, was added to the reaction at 1% based on the total mass of the reactants. The product was then filtered to remove the salts, silica mixture, as well as other impurities.

TABLE 5
Examples

| Components by | | | | | |
|---|---|---|---|---|---|
| Weight | A3 | A4 | A5 | A6 | A7 |
| Fatty acid dimer | 4% | 2.5% | 6% | 0.35% | 8.4% |
| (T18 Dimer) | | | | | |
| Stearic Acid | 13% | | | | |
| (TRV 1655) | | | | | |
| Stearic Acid | | 2.5% | 6% | 29.835% | 5.6% |
| (TRV 1890) | | | | | |
| Fully Hydro Caster oil | 83% | 95% | 88% | 59.835% | 86% |
| Fully Hydro Soy oil | | | | 10% | |
| Drop melting Point | 62.33 | 56.7(3) | 43.2(3) | 41.1 (4) | 51.27 |
| (° C.) | | | | | |
| Cone Penetration at | | | | | |
| 25° C. | | | | | |
| Kinetic Viscosity at | | | | | |
| 100° C. (mm2/s) | | | | | |
| Lovibond Color 5 ¼ | | | | | |
| Ly/Lr | | | | | |
| Congealing point (° C.) | | | | | |
| Hydroxyl Value | 162.8 | 120.7 | 98.53(3) | 29.37 (4) | 73.5 |
| Acid value | | | | | |
| Iodine Value | | | | | |
| TGA | | | | | |
| Mn/Mw (Da) | 1453/1784 | 1511.5/1921 | 1653/2398 | 1788/1498.33 | 1808/2749 |
| PDI | 1.23(2) | 1.311(2) | 1.45(3) | 1.19 (3) | 1.52 |

Replicate number may be included in ( ) in any value.

### Exemplary Aspects

The following exemplary aspects are provided, the numbering of which is not to be construed as designating levels of importance:

Para. A: A wax formulation comprising:
about 5 weight percent (wt %) to about 85 wt % of a natural oil-based petrolatum composition based on total weight of the wax formulation; and
about 1 wt % to about 95 wt % of a wax material based on total weight of the wax formulation;
wherein the natural oil-based petrolatum composition comprises an esterification product of a pre-esterification mixture comprising:
   about 0.1 wt % to about 40 wt % of a fatty acid dimer based on total weight of the pre-esterification mixture,
   about 99.9 wt % to about 60 wt % of one or more components selected from the group consisting of C2-C6 polyols, natural oils, hydrogenated natural oils, fatty acids, and acyl glycerols, based on total weight of the pre-esterification mixture,
   wherein the natural oil-based petrolatum composition has a cone penetration value of greater than 10 and a polydispersity index greater than 1.3.

Para. B: The wax formulation of Para. A, wherein the natural oil-based petrolatum has iodine value less than 5.

Para. C: The wax formulation of Para. A or Para. B, wherein the natural oil-based petrolatum has an iodine value of about 0.5 to about 5.0.

Para. D: The wax formulation of any one of Paras. A-C, wherein the wax formulation comprises about 15 wt % to about 85 wt %, preferably 20 wt % to 80 wt %, of the natural oil-based petrolatum composition.

Para. E: The wax formulation of any one of Paras. A-D, wherein the wax formulation comprises about 10 wt % to about 65 wt % of the wax material.

Para. F: The wax formulation of any one of Paras. A-E, wherein the wax material comprises beeswax, paraffin wax, plant-based waxes, natural oil-based waxes, microcrystalline waxes, or mixtures thereof.

Para. G: The wax formulation of any one of Paras. A-F, wherein the wax material comprises natural oil-based waxes.

Para. H: The wax formulation of any one of Paras. A-G, wherein the wax formulation further comprises 0 wt % to about 85 wt % of a natural oil based on total weight of the wax formulation.

Para. I The wax formulation of any one of Paras. A-H, wherein the wax formulation further comprises about 20 wt % to about 80 wt % of natural oils based on total weight of the wax formulation.

Para. J: The wax formulation of any one of Paras. A-I, wherein the natural oils comprise interesterified natural oils, hydrogenated natural oils, or combinations thereof, preferably interesterified soybean oil, interesterified coconut oil, hydrogenated soybean oil, or combinations of two or more thereof.

Para. K: The wax formulation of any one of Paras. A-J, wherein the wax formulation has a melt point in the range of about 100° F. to about 150° F., preferably a melt point in the range of about 110° F. to about 140° F.

Para. L: The wax formulation of any one of Paras. A-K, wherein the wax formulation exhibits improved fragrance throw.

Para. M: The wax formulation of any one of Paras. A-L, wherein the wax formulation exhibits improved performance based on one or more of cracking, top appearance, pull away, hardness, filming, or fat bloom when formulated for use in candle wax applications.

Para. N: candle wax composition comprising a wax formulation according to any one of Paras. A-M.

Para. O: The candle wax composition of Para. N, wherein the composition comprises about 1 wt % to 100 wt %, preferably about 5 wt % to about 70 wt %, of the wax formulation based on total weight of the candle wax composition.

Para. P: The candle wax composition of Para. O further comprising an additive comprising wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

Para. Q: The candle wax composition of Para. P, wherein the composition comprises about 0.1 wt % to about 30 wt % of the at least one additive based on total weight of the candle wax composition.

Para. R: The candle wax composition of any one of Paras. N-Q, wherein the composition comprises about 0.1 wt % to about 30 wt % of the at least one additive based on total weight of the candle wax composition.

Para. S: The candle wax composition of any one of Paras. N-R, wherein the candle wax composition exhibits improved fragrance throw.

Para. T: The candle wax composition of any one of Paras. N-S, wherein the candle wax composition exhibits improved performance based on one or more of cracking, top appearance, pull away, hardness, filming, or fat bloom.

Para. U: A candle comprising a wick in a candle wax composition, wherein the candle wax composition comprises:
a wax formulation comprising about 5 wt % to about 85 wt % of a natural oil-based petrolatum composition based on total weight of the wax formulation; and about 1 wt % to about 95 wt % of a wax material based on total weight of the wax formulation;
wherein the natural oil-based petrolatum composition comprises an esterification product of a pre-esterification mixture comprising:
   about 0.1 wt % to about 40 wt % a fatty acid dimer based on total weight of the pre-esterification mixture,
   about 99.9 wt % to about 60 wt % of one or more components selected from the group consisting of C2-C6 polyols, natural oils, hydrogenated natural oils, fatty acids, and acyl glycerols, based on total weight of the pre-esterification mixture,
   wherein the natural oil-based petrolatum composition has a cone penetration value of greater than 10 and a polydispersity index of greater than 1.3.

Para. V: The candle of Para. U, wherein the natural oil-based petrolatum has an iodine value of about 0.5 to about 5.0.

Para. W: The candle of Para. U or Para. V, wherein the wax formulation comprises about 15 wt % to about 85 wt %, preferably about 20 wt % to about 80 wt %, of the natural oil-based petrolatum composition.

Para. X: The candle of any one of Paras. U-W, wherein the wax formulation comprises about 10 wt % to about 65 wt % of the wax material.

Para. Y: The candle of any one of Paras. U-X, wherein the wax material comprises beeswax, paraffin-based waxes, plant-based waxes, natural oil-based waxes, micro-crystalline waxes or mixtures thereof.

Para. Z: The candle of any one of Paras. U-Y, wherein the wax material comprises natural oil-based waxes.

Para. AA: The candle of any one of Paras. U-Z, wherein the wax material comprises natural oil-based waxes.

Para. AB: The candle of any one of Paras. U-AA, wherein the wax formulation further comprises 0 wt % to about 85 wt % of natural oils based on total weight of the wax formulation.

Para. AC: The wax formulation of any one of Paras. U-AB, wherein the wax formulation further comprises about 20 wt % to about 80 wt % of natural oils based on total weight of the wax formulation.

Para. AD: The wax formulation of any one of Paras. U-AC, wherein the natural oils comprise interesterified natural oils, hydrogenated natural oils, or combinations thereof, preferably interesterified soybean oil, interesterified coconut oil, hydrogenated soybean oil, or combinations of two or more thereof.

Para. AE: The candle of any one of Paras. U-AD, wherein the wax formulation has a melt point in the range of about 100° F. to about 150° F., preferably a melt point in the range of about 110° F. to about 140° F.

Para. AF: The candle of any one of Paras. U-AE, wherein the candle wax composition comprises about 1 wt % to 100 wt % of the wax formulation.

Para. AG: The candle of any one of Paras. U-AF further comprising an additive comprising wax-fusion enhancing additives, coloring agents, scenting agents, migration inhibitors, free fatty acids, surfactants, co-surfactants, emulsifiers, additional optimal wax ingredients, or mixtures thereof.

Para. AH: The candle of any one of Paras. U-AG, wherein the candle exhibits improved fragrance throw, wherein the candle wax composition exhibits improved performance based on one or more of cracking, top appearance, pull away, hardness, filming, or fat bloom.

Para. AI: The candle of any one of Paras. U-AH, wherein the candle wax composition exhibits improved performance based on one or more of cracking, top appearance, pull away, hardness, filming, or fat bloom.

Para. AJ: A method for preparing a wax formulation of any one of Paras. A-M, the method comprising:
heating a wax material to a temperature wherein the wax material is in a molten state; and
combining the wax material in a molten state with a natural oil-based petrolatum composition;
wherein the natural oil-based petrolatum composition comprises an esterification product of a pre-esterification mixture comprising:
   about 0.1 wt % to about 40 wt % a fatty acid dimer based on total weight of the pre-esterification mixture,
   about 99.9 wt % to about 60 wt % of one or more components selected from the group consisting of C2-C6 polyols, natural oils, hydrogenated natural oils, fatty acids, and acyl glycerols, based on total weight of the pre-esterification mixture,
   wherein the natural oil-based petrolatum composition has a cone penetration value of greater than 10 and a polydispersity index of greater than 1.3.

Each of the non-limiting aspects above can stand on its own or can be combined in various permutations or combinations with one or more of the other aspects or other subject matter described in this document. While the invention has been illustrated and described in certain aspects, a person with ordinary skill in the art, after reading the foregoing specification can effect changes, substitutions of equivalents and other types of alterations to the present technology as set forth herein. Each aspect described above can also have included or incorporated therewith such variations or aspects as disclosed in regard to any or all of the other aspects.

The present technology is also not to be limited in terms of the particular aspects described herein, which are intended as single illustrations. Many modifications and variations of this present technology can be made without departing from its spirit and scope, as will be apparent to those skilled in the art from the foregoing descriptions. Such modifications and variations are intended to fall within the scope of the appended claims. It is to be understood that this present technology is not limited to particular methods, reagents, compounds, or compositions, which can, of course, vary. It is also to be understood that the terminology used herein is for the purpose of describing particular aspects only and is not intended to be limiting. Thus, it is intended that the specification be considered as exemplary only with the breadth, scope and spirit of the present technology indicated only by the appended claims, definitions therein and any equivalents thereof.

The aspects, illustratively described herein may suitably be practiced in the absence of any element or elements, limitation or limitations, not specifically disclosed herein. Thus, for example, the terms “comprising,” “including,” “containing,” etc. shall be read expansively and without limitations. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter form the genus, regardless of whether or not the excised material is specifically.

1. A wax formulation comprising:
about 5 weight percent (wt %) to about 85 wt % of a natural oil-based petrolatum composition based on total weight of the wax formulation; and
about 1 wt % to about 95 wt % of a wax material based on total weight of the wax formulation;
wherein the natural oil-based petrolatum composition comprises an esterification product of a pre-esterification mixture comprising:
about 0.1 wt % to about 40 wt % of a fatty acid dimer based on total weight of the pre-esterification mixture,
about 99.9 wt % to about 60 wt % of one or more components selected from the group consisting of C2-C6 polyols, natural oils, hydrogenated natural oils, fatty acids, and acyl glycerols, based on total weight of the pre-esterification mixture,
wherein the natural oil-based petrolatum composition has a cone penetration value of greater than 10 and a polydispersity index greater than 1.3.

2. The wax formulation of claim 1, wherein the natural oil-based petrolatum has iodine value less than 5.

3. The wax formulation of claim 1, wherein the natural oil-based petrolatum has an iodine value of about 0.5 to about 5.0.

4. The wax formulation of claim 1, wherein the wax formulation comprises about 15 wt % to about 85 wt % of the natural oil-based petrolatum composition.

5. The wax formulation of claim 1, wherein the wax formulation comprises about 10 wt % to about 65 wt % of the wax material.

6. The wax formulation of claim 1, wherein the wax material comprises natural oil-based waxes.

7. The wax formulation of claim 1, wherein the wax formulation further comprises 0 wt % to about 85 wt % of a natural oil based on total weight of the wax formulation.

8. The wax formulation of claim 1, wherein the wax formulation has a melt point in the range of about 100° F. to about 150° F.

9. A candle wax composition comprising a wax formulation according to claim 1.

10. The candle wax composition of claim 9, wherein the composition comprises about 1 wt % to 100 wt % of the wax formulation based on total weight of the candle wax composition.

11. The candle wax composition of claim 9 further comprising an additive comprising wax-fusion enhancing additives, coloring agents, scenting agents, migration inhibitors, free fatty acids, surfactants, co-surfactants, emulsifiers, additional optimal wax ingredients, monoglycerides, diglycerides, distilled monoglycerides, or mixtures thereof.

12. The candle wax composition of claim 11, wherein the composition comprises about 0.1 wt % to about 30 wt % of the at least one additive based on total weight of the candle wax composition.

13. A candle comprising a wick in a candle wax composition, wherein the candle wax composition comprises:
a wax formulation according to claim 1.

14. A method for preparing a wax formulation of claim 1, the method comprising:
heating a wax material to a temperature wherein the wax material is in a molten state; and
combining the wax material in a molten state with a natural oil-based petrolatum composition;
wherein the natural oil-based petrolatum composition comprises an esterification product of a pre-esterification mixture comprising:
about 0.1 wt % to about 40 wt % a fatty acid dimer based on total weight of the pre-esterification mixture,
about 99.9 wt % to about 60 wt % of one or more components selected from the group consisting of C2-C6 polyols, natural oils, hydrogenated natural oils, fatty acids, and acyl glycerols, based on total weight of the pre-esterification mixture,
wherein the natural oil-based petrolatum composition has a cone penetration value of greater than 10 and a polydispersity index of greater than 1.3.
